(19) United States
(12) Patent Application Publication
(10) Pub. No.: US 2016/0253404 A1
(43) Pub. Date: Sep. 1, 2016

(54) DATABASE-CONTROLLED INFORMATION LIFECYCLE MANAGEMENT

(71) Applicant: Toni Fabijancic, Eppelheim (DE)

(72) Inventor: Toni Fabijancic, Eppelheim (DE)

(21) Appl. No.: 14/632,524

(22) Filed: Feb. 26, 2015

(51) Int. Cl. G06F 17/30

(52) U.S. Cl. CPC G06F 17/30595; G06F 17/30356; G06F 17/30575

(57) ABSTRACT

According to an embodiment of the present disclosures, systems, methods, and non-transitory computer-readable mediums having program instructions thereon, provide for managing a data record's lifecycle with a database. The lifecycle of the data records in the database is managed and performed on the data records in the database and not on archived files. In an embodiment, the database includes a modeling layer, a rules layer, and a service layer. The modeling layer instructs the database (i) how a business object is set and (ii) how the database can retrieve the business object. The rules layer connects a rule to the business object with a database rules object. The service layer checks the data records of the business object to determine if a rule criteria defined by the corresponding database rules object is met.

### FIELD

The present disclosure relates generally to a database-controlled information lifecycle management of data records.

### BRIEF DESCRIPTION OF THE DRAWINGS

The accompanying drawings illustrate the various embodiments and, together with the description, further serve to explain the principles of the embodiments and to enable one skilled in the pertinent art to make and use the embodiments.

FIG. 1 illustrates an embodiment of a system for managing the lifecycle of data records with a database.

FIG. 2A illustrates an embodiment of the database, and its components, utilized to manage the lifecycle of data records.

FIG. 2B illustrates an embodiment of data tables included in the persistence of the database.

FIG. 2C illustrates an embodiment of the modeling layer of the database.

FIG. 2D illustrates an embodiment of the rules layer of the database.

FIG. 2E illustrates an embodiment of the persistence of the database including the data tables and the corresponding business objects and database rules objects.

FIG. 3 illustrates an embodiment of the interaction between the elements of the system.

FIG. 4 illustrates an embodiment of a method for managing the lifecycle of data records with the database.

### DETAILED DESCRIPTION

According to an embodiment of the present disclosures, systems, methods, and non-transitory computer-readable mediums having program instructions thereon, provide for managing the lifecycle of data records with a database. The managing of the lifecycle of data records is generally known as information lifecycle management. In an embodiment, information lifecycle management refers to the process of maintaining and destroying data. In an embodiment, for a variety of reasons, certain data might need to be retained for a specified period of time. Similarly, in an embodiment, certain data can only be destroyed after a specified period of time has elapsed. For example, a business may be required to retain certain data for business (e.g., maintain employee records) and/or legal (e.g., taxes, audits, lawsuits, regulatory) purposes for a specified period of time. In an embodiment, certain data records might need to be maintained for only a few months (e.g., employee records) while other data records (e.g., data records required for tax, audit, lawsuit or regulatory purposes) might need to be maintained for a much longer period of time (e.g., years to decades). Accordingly, information lifecycle management sets the policies for the automatic data retention (i.e., the minimum and maximum retention time) and subsequent destruction of a business' data records. Accordingly, with information lifecycle management, a business is able to responsibly comply with the legal requirements of the jurisdiction in which it operates.

However, current solutions involving information lifecycle management are possible only on archived data stored in a storage system distinct from the database. However, accessing data archived in a storage system is not as fast or efficient as accessing data directly from the database. Further, not many storage systems are certified to perform the necessary functions corresponding to the retention and destruction of archived data as required by various information lifecycle management policies. Further, under the current information lifecycle management solutions, in order to archive certain data, a software application is first required to define (i.e., with SQL statements, SELECT and JOIN) a business object (i.e., data object representing the logical grouping of data tables which would make sense in a business environment) from the set of different data tables in the relational database model within the database. For example, there can be one business object dedicated to employees and another dedicated to material. In an embodiment, the employee business object can be a logical grouping of data tables corresponding to employee information (e.g., names, addresses and bank accounts). Similarly, the material business object can be a logical grouping of data tables corresponding to material information (e.g., type, weight, origin). Further, in an embodiment, an instance of a business object refers to a logical grouping of related data records in the data tables (e.g., specific employee information or material information).

After the business object is defined by the software application, the software application has to then define another data object (i.e., an archiving object) in order to archive the desired data records represented by the business object. In an embodiment, the archiving object corresponds to the logical grouping of related data tables defined by the business object. However, in an embodiment, the structure (i.e., the logical grouping of related data tables) of the business object is defined separately in the archiving object definition. Also, the logic required to select an archiving object needs to be implemented in a separate write program (i.e., an archiving write program). Further, a separate rules program (i.e., including the retention and destruction rules corresponding to the data records within the data tables) is also required. Moreover, the structure (i.e., corresponding to the logical grouping or related data tables) of an archived business object can change throughout the lifetime of the archived business object in the database (e.g., if there are some fields within the data tables that are no longer relevant for the archived business object). For example, in an embodiment, archiving object A1 corresponds to archived records R1, R2 and R3. If the separate rule program specifies that: (i) record R2 needs to be destroyed and (ii) records R1 and R3 should still be retained, then records R1 and R3 of archiving object A1 would be copied to a new archiving object A2 and archiving object A1 would be deleted (along with records R1, R2, and R3 of archiving object A1).

Further, each of the data tables containing the data records defined by a specific business object belong to a specific software application. Moreover, only the software applications include the logic required to retrieve a specific business object from the data tables in the database. Accordingly, with the current solutions, only the software application, itself, understands what the business object corresponds to. In other words, the database merely responds to SQL statements from a software application but does not, itself, understand which logical grouping of data tables (i.e., the relational model) the business objects correspond to (e.g., the database merely knows about the relationships between different data tables due to the foreign key relationships between the data in the different data tables).

In an embodiment, the present invention dispenses with archiving data records on a storage system distinct from the database and, instead, manages the lifecycle of data records within the database. Therefore, the lifecycle of the data records in the database is managed and performed on the data records in the database and not on archived files.

In an embodiment, the database (e.g., an in-memory, relational database management system) includes, in addition to a persistence layer of the database, a modeling layer, a rules layer, and a service layer. In an embodiment, the modeling layer allows a developer to model a business object within the database. In other words, in an embodiment, the modeling layer instructs the database (i) how the business object is set together (i.e., how the different data tables are logically grouped) and (ii) how the database can retrieve the business object, itself. Therefore, in an embodiment, instead of merely utilizing SQL statements from logic in software applications to define a business object, the database now understands which logical grouping of data tables the business objects correspond to.

In an embodiment, the rules layer allows the developer to connect a rule to the business object with a database rules object. In an embodiment, the database rules object contains information pertaining to the lifecycle of the business object. For example, the information in the database rules object may pertain to: (i) what the minimum and maximum retention time of the business object is and (ii) when certain data needs to be destroyed. In another embodiment, the information in the database rules object may also pertain to access rights (e.g., (i) who can access certain data, (ii) when, and for how long, access to certain data is restricted and (iii) when, and for how long, access to certain data is permitted).

In an embodiment, the service layer is directed to automatically checking the data records of the business object to determine if a rule criteria defined by the corresponding database rules object is met. For example, if a certain data record (e.g., time elapsed from creation) corresponding to a business object satisfies a rule requirement defined by the corresponding database rules object requiring the destruction of the data record, then the service layer will destroy the data record and the related data records in the data tables corresponding to the business object. For example, in embodiment, in an employee business object (i.e., dedicated to employee information), if (i) one of the rules in the database rules object stated that “employee records held three months after the departure of the employee must be deleted” and (ii) a certain employee's “time after departure” data records exceeds three months, then the service layer will remove from the database all the records corresponding to that employee. In other words, the service layer will remove the data records corresponding to that specific instance of the business object. Similarly, in an embodiment, if the “time after departure” data record of another employee does not exceed three months, then the service layer will not remove any records corresponding to that employee from the database. In other words, the service layer will maintain the data records corresponding to that specific instance of the business object. In another embodiment, the service layer also controls the access (e.g., (i) who can access certain data, (ii) when, and for how long, access to certain data is restricted and (iii) when, and for how long, access to certain data is permitted) to the data records in the database.

In an embodiment, the data tables containing the data records and the corresponding business object and database rules object are all in the persistence layer of the database.

In another embodiment, the modeling layer, the rules layer and the service layer could all be implemented in a software layer above the database layer. Further, in an embodiment, the software layer is implemented in a graphical user interface application. For example, in an embodiment, in the software layer, the service layer is (i) scheduled to select, via SQL statements, business objects within the database and (ii) perform a check of the data records (i.e., corresponding to business object) in the database to determine if a rule criteria defined by the corresponding database rules object (e.g., which is defined by a rules layer within the software layer) is met. Further, in an embodiment, if a data record meets the destruction rules criteria, the software layer then deletes the relevant data records in the database via a delete statement. Accordingly, in an embodiment, because all the logic (i.e., for the modeling layer, the rules layer and the service layer) occurs in the software layer, the graphical user interface application implementing the software layer could be used with any type of database (e.g., an in-memory, relational database management system).

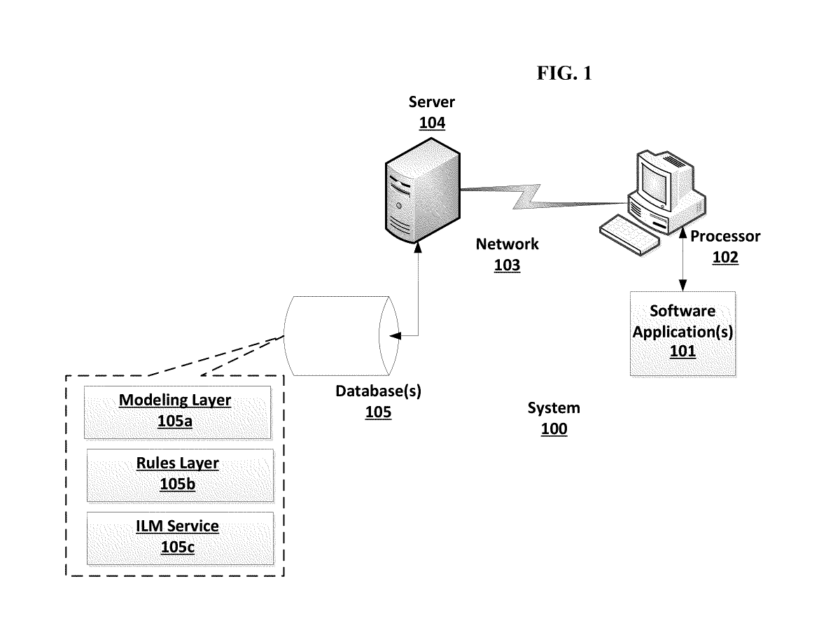

FIG. 1 illustrates an embodiment of a system for managing the lifecycle of data records with a database. In an embodiment, the system 100 consists of software application(s) 101, a processor (with a display) 102, a network 103, a server 104, databases 105 (including modeling layer 105a, rules layer 105b, information lifecycle management service (“ILM service”) 105c. Further, in an embodiment, database(s) 105 is an in-memory database.

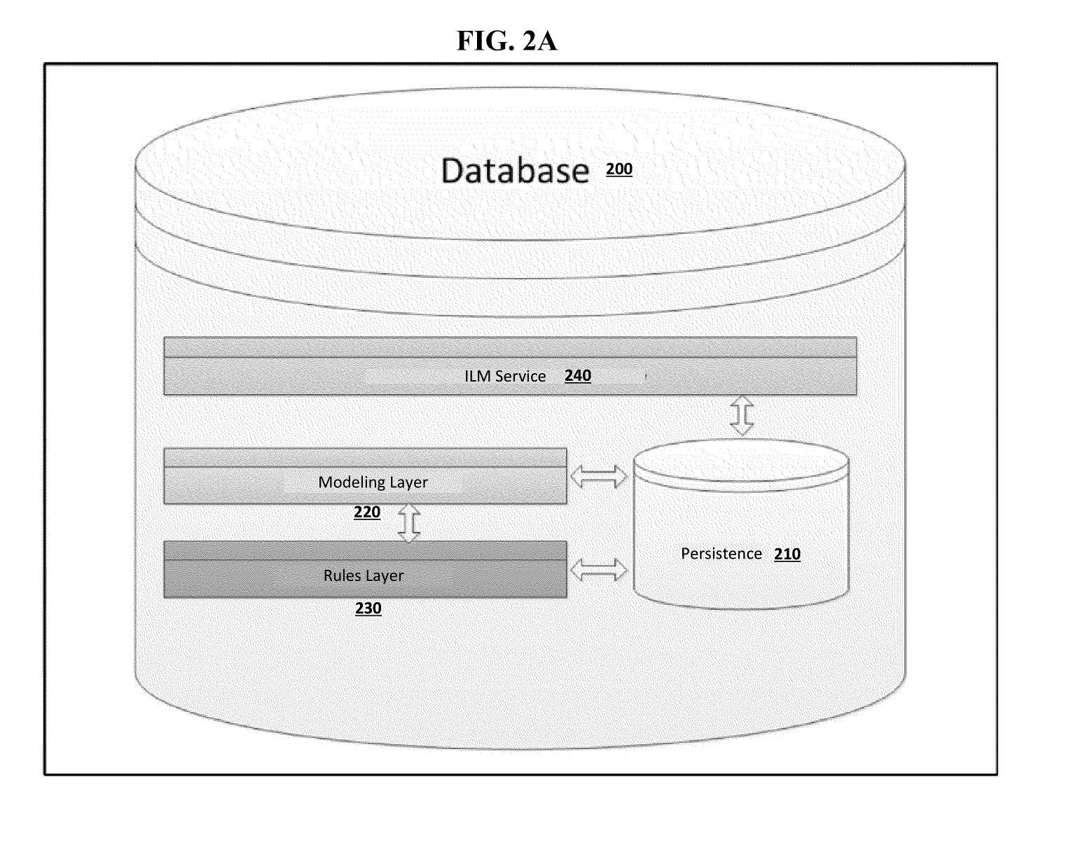

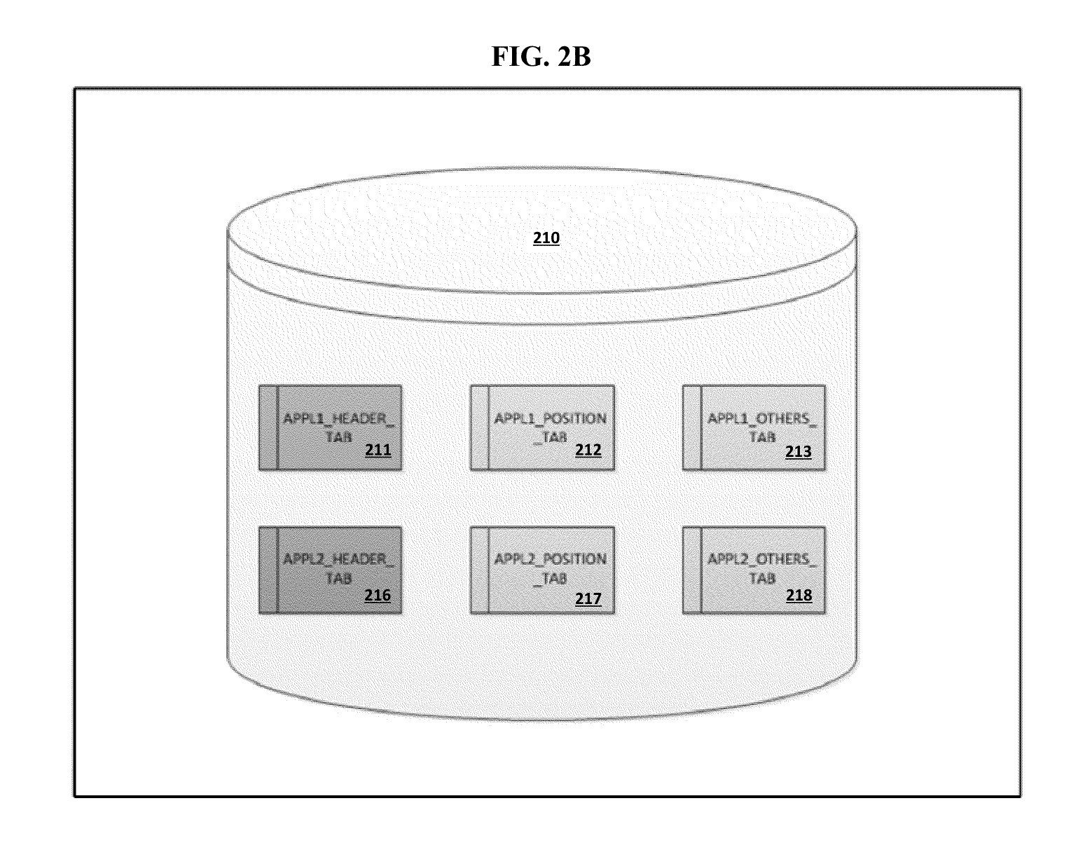

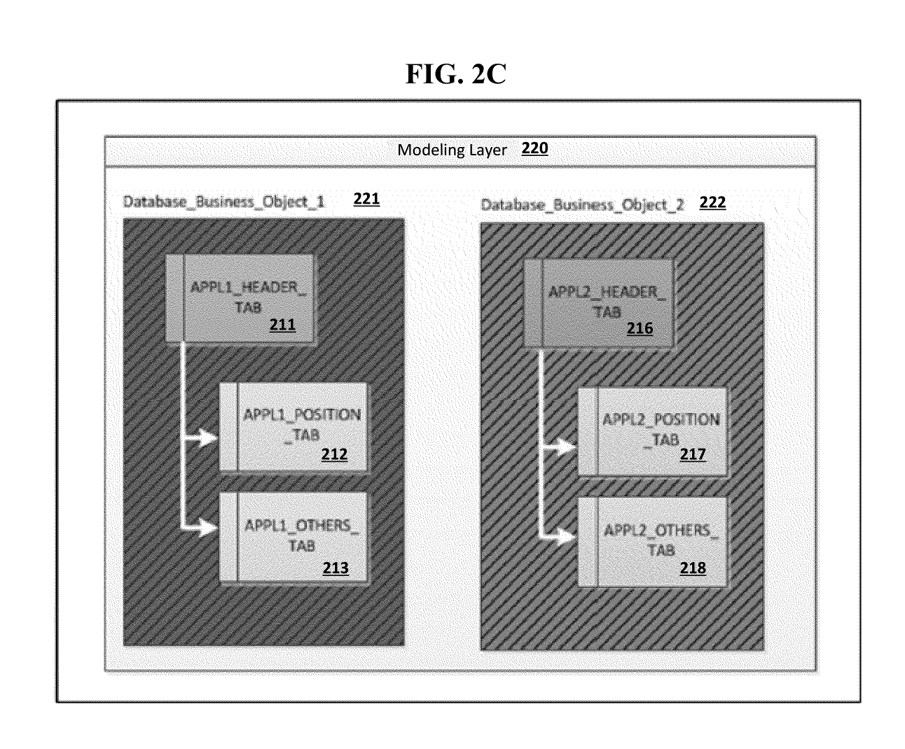

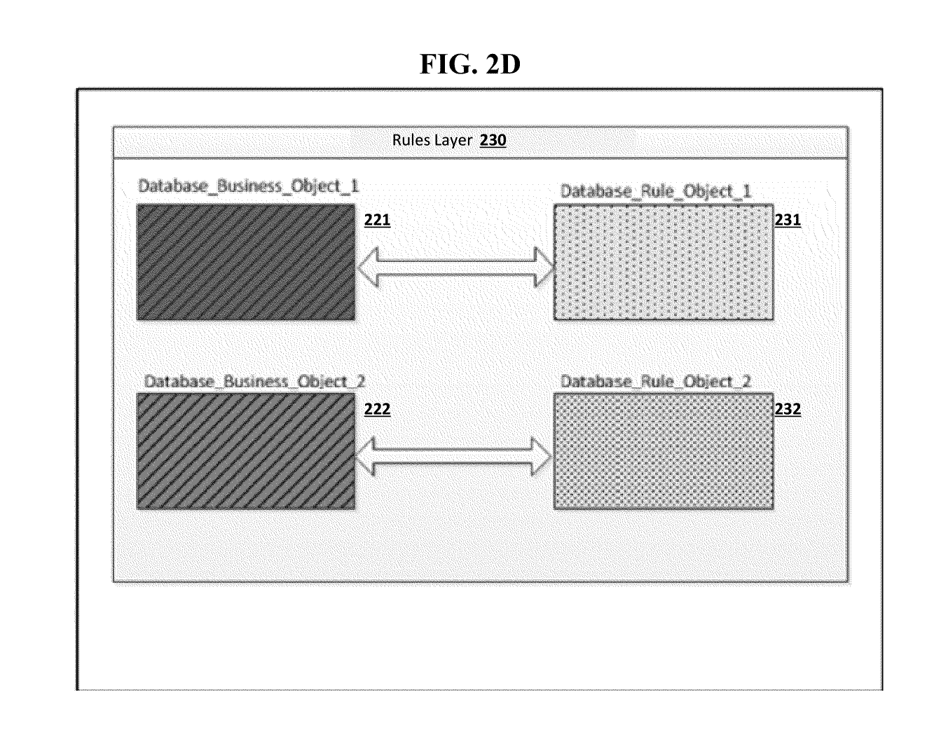

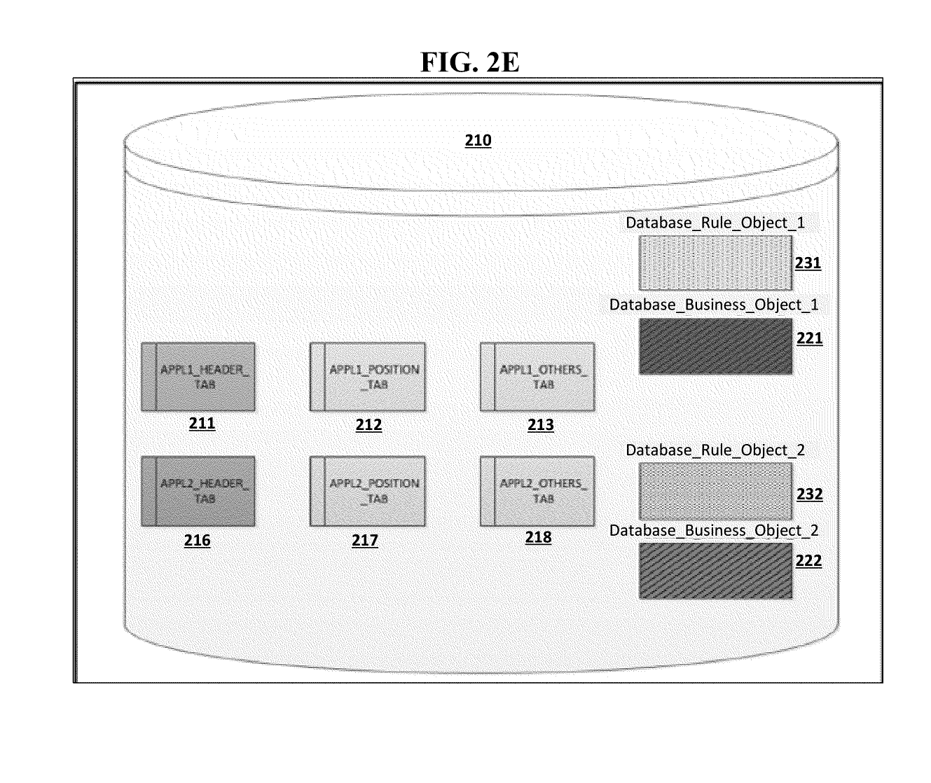

FIG. 2A illustrates an embodiment of the database, and its components, utilized to manage the lifecycle of data records. In an embodiment, database 200 includes a persistence 210, a modeling layer 220, a rules layer 230 and a database-controlled information lifecycle management service (“ILM service”) 240.

FIG. 2B illustrates an embodiment of data tables included in the persistence of the database. In an embodiment, persistence 210 includes data tables 211, 212, 213, 214, 215, and 216. In an embodiment, data tables 211, 212, 213 are related to each other. In an embodiment, data tables 211, 212, and 213 relate to the same application. In an embodiment, data table 211 is the header table, data table 212 is the position table and data table 213 contains “other” information. In an embodiment, data tables 211, 212, and 213 can refer to an application containing a business' employees. For example, data table 211 can include the identification information of the employees, data table 212 can include the address information of the employees, and data table 213 can include bank account information of the employees. Similarly, in an embodiment, data tables 216, 217, 218 are related to each other. In an embodiment, data tables 216, 217, and 218 relate to the same application. In an embodiment, data table 216 is the header table, data table 217 is the position table and data table 218 contains “other” information. In an embodiment, data tables 216, 217, and 218 can refer to an application for managing a business' materials. For example, data table 216 can include the types of material (e.g., silver, gold, copper), data table 217 can include the country of origin of the material, and data table 218 can include the weight of the material.

FIG. 2C illustrates an embodiment of the modeling layer of the database. In an embodiment, modeling layer 220 defines business object 221 as a logical grouping of data tables 211, 212, and 213 and defines business object 222 as a logical grouping of data tables 216, 217, and 218.

FIG. 2D illustrates an embodiment of the rules layer of the database. In an embodiment, rules layer 230 assigns database rules object 231 to business object 221 and assigns database rules object 232 to business object 222.

FIG. 2E illustrates an embodiment of the persistence of the database including the data tables and the corresponding business objects and database rules objects. In an embodiment, persistence includes data tables 211, 212, 213, 216, 217 and 218, business objects 221 and 222 and database rules objects 231 and 232.

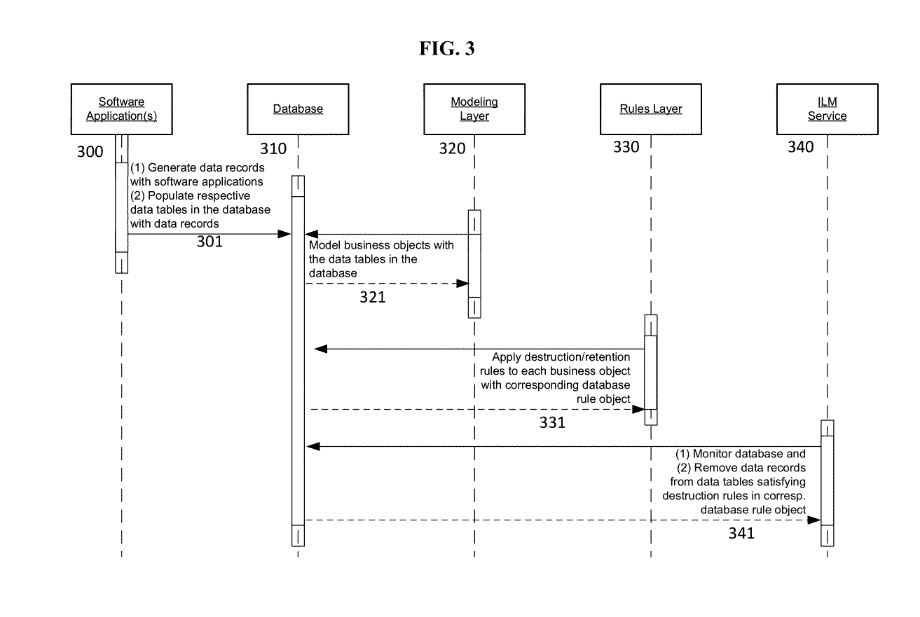

FIG. 3 illustrates an embodiment of the interaction between the elements of the system. In step 301, (i) data records are generated by software application(s) 300 and (ii) software application(s) 300 populates the respective data tables in database 310 with the generated data records. Further, in an embodiment, step 301 can also include the feature (not shown in FIG. 3) of blocking, with ILM service 340 of the database 310, software application(s) 300 from accessing certain data records in the database 310. In step 321, modeling layer 320 of the database 310 models business objects corresponding to logical groupings of the data tables in the database 310. In step 331, rules layer 330 of the database 310 assigns retention and destruction rules to the business objects determined in 321 with corresponding database rules objects. Lastly, in step 341, the ILM service 340 (i) monitors the database 310 and (ii) removes data records from the data tables in the database 310 satisfying the destruction rules in the corresponding rules object.

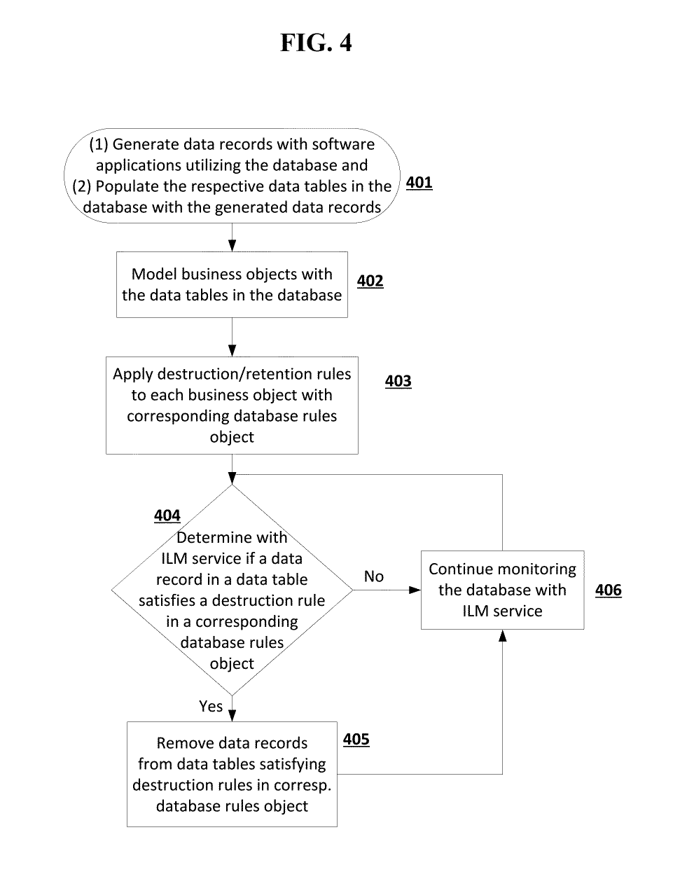

FIG. 4 illustrates an embodiment of a method for managing the lifecycle of data records with the database. In step 401, (i) data records are generated with software applications utilizing the database and (ii) the respective data tables in the database are populated with the generated data records. Further, in an embodiment, step 401 can also include the feature (not shown in FIG. 4) of blocking, with the ILM service, software applications from accessing certain data records in the database. In step 402, business objects are modeled with the data tables in the database. In step 403, retention and destruction rules are applied to the business objects modeled in step 402 with the corresponding database rules objects. In step 404, the ILM service determines whether a data record in a data table satisfies a destruction rule in the corresponding database rules object. If, in step 404, a data record in a data table satisfies a destruction rule in the corresponding database rules object, then in step 405, the data record and related data records in the data tables corresponding to the business object will be removed from the database. On the other hand, if in step 404, no data records in any of the data tables satisfy a destruction rule in any of the corresponding database rules objects, then, in step 406, the data records will be maintained and the ILM service will continue monitoring the database.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

Although the foregoing invention has been described in some detail for purposes of clarity of understanding, it will be apparent that certain changes and modifications can be practiced within the scope of the appended claims. The described embodiment features can be used with and without each other to provide additional embodiments of the present invention. The present invention can be practiced according to the claims without some or all of these specific details. For the purpose of clarity, technical material that is known in the technical fields related to the invention has not been described in detail so that the present invention is not unnecessarily obscured. It should be noted that there are many alternative ways of implementing both the process and apparatus of the present invention. Accordingly, the present embodiments are to be considered as illustrative and not restrictive, and the invention is not to be limited to the details given herein, but can be modified within the scope and equivalents of the appended claims.

What is claimed is:

1. A computer-implemented method for managing data lifecycle in a database:
modeling a business object, with a modeling layer of the database, wherein the business object is a logical grouping of data tables in the database;
assigning, with a rules layer of the database, a database rules object to the business object, wherein the database rules object contains rules pertaining to at least one of (i) minimum retention time of data records in the data tables corresponding to the business object, (ii) maximum retention time of the data records in the data tables corresponding to the business object, and (iii) time of destruction for the data records in the data tables corresponding to the business object; and
upon determining, with a service layer of the database, that at least one data record in the data tables corresponding to the business object satisfies the rule pertaining to time of destruction, removing, with the service layer of the database, the at least one data record and other related data records corresponding the business object.

2. The method of claim 1, wherein the database is an in-memory, relational database management system.

3. The method of claim 1, wherein the service layer restricts access of certain data records in the database.

4. The method of claim 1, wherein the modeling layer, the rules layer and the service layer are implemented in a software layer above a database layer.

5. The method of claim 1, wherein the database rules object further contains rules pertaining to at least one of (i) which users can access certain data records, (ii) when, and for how long, access to certain data records are restricted and (iii) when, and for how long, access to certain data records are permitted.

6. The method of claim 1, wherein the determining step is performed automatically by the service layer of the database.

7. The method of claim 1, wherein a logical grouping of a data records among related data tables corresponding to the business object is an instance of the business object.

8. A non-transitory computer readable medium containing program instructions for managing data lifecycle in a database, wherein execution of the program instructions by one or more processors of a computer system causes one or more processors to carry out the steps of:
modeling a business object, with a modeling layer of the database, wherein the business object is a logical grouping of data tables in the database;
assigning, with a rules layer of the database, a database rules object to the business object, wherein the database rules object contains rules pertaining to at least one of (i) minimum retention time of data records in the data tables corresponding to the business object, (ii) maximum retention time of the data records in the data tables corresponding to the business object, and (iii) time of destruction for the data records in the data tables corresponding to the business object; and
upon determining, with a service layer of the database, that at least one data record in the data tables corresponding to the business object satisfies the rule pertaining to time of destruction, removing, with the service layer of the database, the at least one data record and other related data records corresponding the business object.

9. The non-transitory computer readable medium of claim 8, wherein the database is an in-memory, relational database management system.

10. The non-transitory computer readable medium of claim 8, wherein the service layer restricts access of certain data records in the database.

11. The non-transitory computer readable medium of claim 8, wherein the modeling layer, the rules layer and the service layer are implemented in a software layer above a database layer.

12. The non-transitory computer readable medium of claim 8, wherein the database rules object further contains rules pertaining to at least one of (i) which users can access certain data records, (ii) when, and for how long, access to certain data records are restricted and (iii) when, and for how long, access to certain data records are permitted.

13. The non-transitory computer readable medium of claim 8, wherein the determining step is performed automatically by the service layer of the database.

14. The non-transitory computer readable medium of claim 8, wherein a logical grouping of a data records among related data tables corresponding to the business object is an instance of the business object.

15. A system directed to managing data lifecycle, comprising of:
a database, the database comprising of:
a modeling layer,
a rules layer,
a service layer,
a processor, wherein the processor is configured to perform the steps of:
modeling a business object, with the modeling layer of the database, wherein the business object is a logical grouping of data tables in the database;
assigning, with the rules layer of the database, a database rules object to the business object, wherein the database rules object contains rules pertaining to at least one of (i) minimum retention time of data records in the data tables corresponding to the business object, (ii) maximum retention time of the data records in the data tables corresponding to the business object, and (iii) time of destruction for the data records in the data tables corresponding to the business object; and
upon determining, with the service layer of the database, that at least one data record in the data tables corresponding to the business object satisfies the rule pertaining to time of destruction, removing, with the service layer of the database, the at least one data record and other related data records corresponding the business object.

16. The system of claim 15, wherein the database is an in-memory, relational database management system.

17. The system of claim 15, wherein the service layer restricts access of certain data records in the database.

18. The system of claim 15, wherein the modeling layer, the rules layer and the service layer are implemented in a software layer in a graphical user interface application, wherein the software layer is above a database layer.

19. The system of claim 15, wherein the database rules object further contains rules pertaining to at least one of (i) which users can access certain data records, (ii) when, and for how long, access to certain data records are restricted and (iii) when, and for how long, access to certain data records are permitted.

20. The system of claim 15, wherein the determining step is performed automatically by the service layer of the database.
